(19) United States
(12) Patent Application Publication
(10) Pub. No.: US 2026/0303954 A1
(43) Pub. Date: Oct. 1, 2026

(54) IMAGE DISPLAY APPARATUS, INFORMATION PROCESSING DEVICE, AND INFORMATION PROCESSING METHOD

(71) Applicant: HONDA MOTOR CO., LTD., Tokyo (JP)

(72) Inventors: Gakuyo FUJIMOTO, Wako-shi, Saitama (JP); Misako KOIKE, Wako-shi (JP); Tsugihiro HAMASUNA, Tokyo (JP)

(73) Assignee: HONDA MOTOR CO., LTD., Tokyo (JP)

(21) Appl. No.: 19/554,741

(22) Filed: Mar. 3, 2026

(30) Foreign Application Priority Data
Mar. 28, 2025 (JP) 2025-056640

(51) Int. Cl. H04N 23/63; G03B 43/00; H04N 7/18; H04N 23/90

(52) U.S. Cl. CPC H04N 23/633; G03B 43/00; H04N 7/181; H04N 23/90

(57) ABSTRACT

There is provided with an image display apparatus configured to display an image to be used for calibration of an imaging device included in a moving body. A first protrusion has predetermined rigidity and includes a first image display unit configured to display a first image and disposed for a first imaging device disposed so as to image an operator inside the moving body. A second protrusion has predetermined rigidity and includes a second image display unit configured to display a second image and disposed for a second imaging device disposed so as to image an outside of the moving body.

### CROSS-REFERENCE TO RELATED APPLICATION(S)

This application claims priority to and the benefit of Japanese Patent Application No. 2025-056640, filed on Mar. 28, 2025, the entire disclosure of which is incorporated herein by reference.

### BACKGROUND OF THE INVENTION

### Field of the Invention

The present invention relates to an image display apparatus, an information processing device, and an information processing method.

### Description of the Related Art

There is a technique for calibrating a plurality of imaging devices included in a moving body such as a vehicle. Japanese Patent No. 6034775 discloses a device that calibrates installation states of a plurality of cameras that captures images for overhead image synthesis.

However, the technique disclosed in Japanese Patent No. 6034775 has a problem that it is difficult to perform calibration in a case where there are few common regions in the imaging ranges of the imaging devices included even in the same moving body.

### SUMMARY OF THE INVENTION

An object of the present invention is to provide a configuration that accurately calibrates an imaging device that images an inside of a moving body and an imaging device that images an outside of the moving body.

According to one embodiment of the present invention, An image display apparatus is configured to display an image to be used for calibration of an imaging device included in a moving body, the image display apparatus comprising: a first protrusion having predetermined rigidity and including a first image display unit configured to display a first image and disposed for a first imaging device disposed so as to image an operator inside the moving body; and a second protrusion having predetermined rigidity and including a second image display unit configured to display a second image and disposed for a second imaging device disposed so as to image an outside of the moving body.

Further features of the present invention will become apparent from the following description of exemplary embodiments (with reference to the attached drawings).

### BRIEF DESCRIPTION OF THE DRAWINGS

FIG. 1 is a bird's eye view illustrating an outline of an image display apparatus and a vehicle;

FIG. 2 is a block diagram illustrating an example of a hardware configuration of an information processing device;

FIG. 3 is a block diagram illustrating an example of a hardware configuration of the image display apparatus;

FIG. 4 is a diagram for explaining an example of a configuration of a first image display unit;

FIG. 5 is a diagram for explaining an example of arrangement of the first image display unit;

FIG. 6 is a block diagram illustrating an example of a functional configuration of the information processing device; and

FIG. 7 is a flowchart illustrating an example of calibration processing performed by the information processing device.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

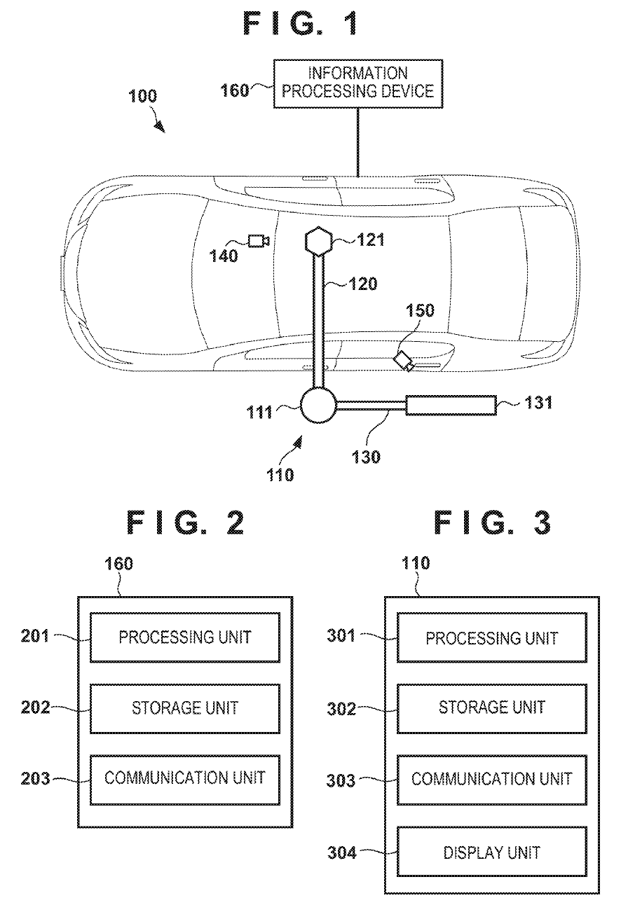

FIG. 1 is a bird's eye view illustrating an outline of a moving body and an image display apparatus that displays an image to be used for calibration of an imaging device included in the moving body according to an embodiment of the present invention. In FIG. 1, a vehicle 100 is used as the moving body, and an image display apparatus 110 is disposed on a side face of the vehicle 100. In addition, the vehicle 100 includes an information processing device 160 as an ECU.

The moving body according to the present embodiment is a moving body that accommodates an operator inside the moving body and executes drive control according to an operation by the operator. In the present embodiment, the description will be given assuming that the vehicle 100 is a sedan-type four-wheeled passenger vehicle, but a moving body different from the vehicle may be adopted as long as similar processing can be executed. In addition, the vehicle 100 according to the present embodiment includes a first imaging device 140 disposed so as to image the operator (driver) inside the vehicle 100, and a second imaging device 150 disposed so as to image the outside of the vehicle 100.

The image display apparatus 110 includes a first protrusion 120 including a first image display unit 121, and a second protrusion 130 including a second image display unit 131. In the image display apparatus 110 according to the present embodiment, the first image display unit 121 is disposed for the first imaging device 140 to display a first image, and the second image display unit 131 is disposed for the second imaging device 150 to display a second image. The image display units and the protrusions will be described later.

FIG. 2 is a block diagram illustrating an example of a hardware configuration of the information processing device 160 according to the present embodiment. The information processing device 160 includes a processing unit 201, a storage unit 202, and a communication unit 203. The processing unit 201 is a processor represented by a CPU, and executes programs stored in the storage unit 202. The storage unit 202 is a storage device such as a RAM, a ROM, or a hard disk. The communication unit 203 includes a wired or wireless communication interface capable of communicating with an external device such as another electric vehicle via a communication network. The programs stored in the storage unit 202 include an application program for using a system according to the present embodiment.

The storage unit 202 stores various data in addition to the programs to be executed by the processing unit 201. The storage unit 202 according to the present embodiment stores various types of information to be used for calibration of the imaging devices. Note that the information processing device 160 according to the present embodiment will be described as an ECU mounted on the vehicle 100, but is not particularly limited thereto as long as it can calibrate the first imaging device 140 and the second imaging device 150 included in the vehicle 100, and may be, for example, a server device or the like. In addition, functions, which will be described as being executed by the information processing device 160, may be shared and performed by the ECU of the vehicle 100 and the server device.

FIG. 3 is a block diagram illustrating an example of a hardware configuration of the image display apparatus 110 according to the present embodiment. The image display apparatus 110 includes a processing unit 301, a storage unit 302, a communication unit 303, and a display unit 304. The processing unit 301 is a processor represented by a CPU, and executes programs stored in the storage unit 302. The storage unit 302 is a storage device such as a RAM, a ROM, or a hard disk. The communication unit 303 includes a wired or wireless communication interface capable of communicating with an external device such as another electric vehicle via a communication network. The programs stored in the storage unit 302 include an application program for using a system according to the present embodiment.

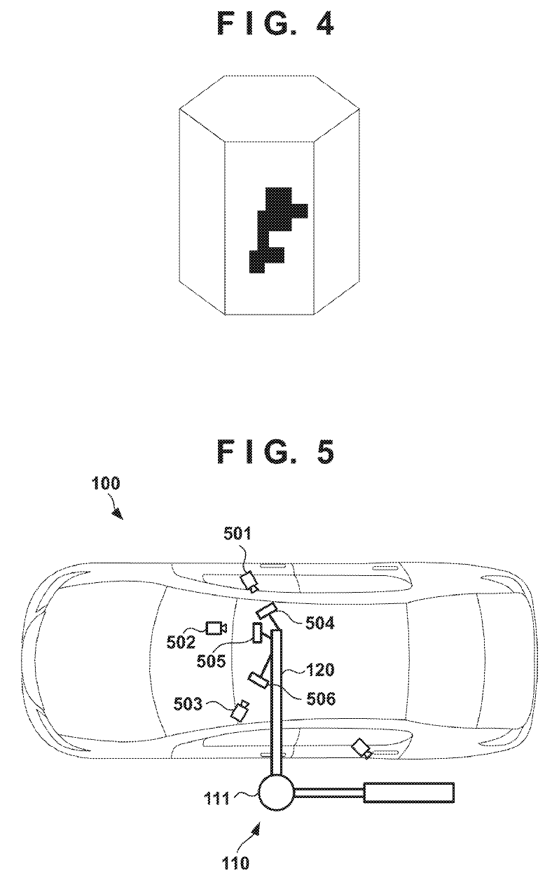

The display unit 304 displays various images. The display of images by the display unit 304 includes display of an image on the first image display unit 121 illustrated in FIG. 1 and display of an image on the second image display unit 131. The first image display unit 121 can employ any general display unit capable of displaying an image, such as a liquid crystal display. Here, the first image display unit 121 can display an image by emitting light at a predetermined wavelength. The display of an image on the first image display unit 121 may be performed by emitting light at a visible light wavelength or may be performed by emitting light at a non-visible light wavelength. As described above, the display of an image by each image display unit 121 can be performed at a wavelength suitable for the corresponding imaging device. In addition, for example, the first image display unit 121 may display the first image in a form where an image appears like a shadow picture by receiving light emission from the back surface. As described above, the first image display unit 121 may display an image in any form as long as the image can be displayed so as to be recognizable by the first imaging device 140. The first image display unit 121 may have a plurality of image display surfaces each capable of displaying an image, and an example of such a configuration will be described later with reference to FIG. 4.

The display of an image on the second image display unit 131 may be performed by projecting light from the first image display unit 121, for example. In this case, the second image display unit 131 itself does not emit light, and an image common to the image displayed on the first image display unit 121 is displayed by the projection light. In addition, for example, the second image display unit 131 may display an image in a form similar to that of the first image display unit 121 (for example, on a liquid crystal display).

The storage unit 302 stores various types of data, in addition to the programs to be executed by the processing unit 301. The storage unit 302 according to the present embodiment stores images to be displayed on the display unit 304 and to be used for calibration of the imaging devices.

Hereinafter, a configuration of the image display apparatus 110 according to the present embodiment will be described. The image display apparatus 110 includes the first protrusion 120 and the second protrusion 130, which have predetermined rigidity. The image display apparatus 110 according to the present embodiment will be described as including the first protrusion 120 and the second protrusion 130, which are rod-shaped protrusions, from a columnar central portion 111. However, the shape of the central portion 111 is not particularly limited as long as the image display apparatus 110 can similarly include protrusions, and the central portion 111 may not be provided.

Hereinafter, when simply referred to as “each protrusion”, which means that it refers to content that does not need to distinguish between the first protrusion 120 and the second protrusion 130. Here, each protrusion is assumed to be a linear rod-shaped protrusion here, but is not particularly limited to such a shape, as long as it can include the first image display unit 121 and the second image display unit 131. Each protrusion may have a shape branched into a plurality of parts, each of which includes an image display unit at its branched tip, for example. In addition, the material of each protrusion is not particularly limited, as long as the protrusion has rigidity capable of holding the first image display unit 121 and the second image display unit 131 at predetermined positions and postures. Any synthetic resin or the like can be used for a frame of the image display apparatus 110 including the protrusions.

As described above, the first protrusion 120 according to the present embodiment is a protrusion for disposing the first image display unit 121 for the first imaging device 140, which is included in the vehicle 100 and is disposed so as to image the driver. Here, the first protrusion 120 is inserted from a central portion 111, which is installed on the side face of the vehicle 100, through the front seat window to the driver's seat area in the vehicle 100, and the first image display unit 121 is disposed for the first imaging device 140 provided in the vehicle 100.

The first image display unit 121 is disposed so as to display the first image at a predetermined position with respect to the first imaging device 140. Here, it is assumed that the first image display unit 121 is disposed so as to display the first image at a position facing the first imaging device 140. The first image display unit 121 may be configured to include only one image display surface or include, for example, a plurality of image display surfaces, each of which may display the first image. The plurality of image display surfaces included in the first image display unit 121 may form a polygonal prism, or may be separated from each other and disposed in such a manner that their positions and postures can be controlled. Here, a plurality of driver monitor cameras (DMC) is disposed in the vehicle 100 as the first imaging device 140, and the first image display unit 121 includes a plurality of image display surfaces so as to display the first image at positions facing the DMCs. Here, “facing” means that an image display surface is disposed perpendicular to the optical axis of the imaging device. However, here, an image display surface may be considered to be “facing” as long as it is substantially perpendicular (for example, by setting a margin of about 5°) even if the image display surface is not in a completely perpendicular posture.

FIG. 4 is a schematic diagram illustrating an example of the first image display unit 121 having a plurality of image display surfaces forming such a polygonal prism. Here, the first image display unit 121 has six surfaces that display the first image, and these surfaces form a hexagonal prism. As described above, the display form of these image display surfaces is not particularly limited as long as the first image can be displayed. For example, these six surfaces may each be a liquid crystal display that displays the first image, or the hexagonal prism may include an infrared lamp inside it so that the first image appears on the six surfaces by light emission of the infrared lamp.

Here, it is assumed that the first image display unit 121 is fixed to the tip of the first protrusion 120. However, as long as the first image display unit 121 is disposed for the first imaging device 140 as described above, the position where the first image display unit 121 is provided is not particularly limited, and may be fixed to an intermediate portion of the first protrusion 120 or may be suspended from a specific portion of the first protrusion 120.

The first image displayed on the first image display unit 121 is an image to be used for calibration of the imaging device as described above. As the first image, an image that can be used in a known calibration technique can be arbitrarily used, and may be, for example, a black-and-white pattern image having a specific shape, or may be a chessboard-like black-and-white pattern image.

Note that the first image display unit 121 may be disposed at a position corresponding to a feature portion of the head of the driver. Here, it is assumed that the first image display unit 121 is disposed so as to display the first image at a position where the driver's eyes are located.

An arrangement example of the plurality of image display surfaces of the first image display unit 121 different from that illustrated in FIG. 4 will be described with reference to FIG. 5. In FIG. 5, for each DMC as the first imaging device 140 included in the vehicle 100, the image display surface of the first image display unit is disposed. Here, for three DMCs 501 to 503, three image display surfaces 504 to 506 disposed so as to face the respective three DMCs extend from first protrusion 120. Here, in a case where each DMC is movable, in order to handle the movement of each DMC, each image display surface is disposed in such a manner that its position and posture can be controlled by operating the connection portion with the first protrusion 120.

As described above, the second protrusion 130 according to the present embodiment is a protrusion for disposing the second image display unit 131 for the second imaging device 150, which is included in the vehicle 100 and is disposed so as to image the outside of the vehicle 100. Here, the second protrusion 130 extends from the central portion 111, which is installed on the side face of the vehicle 100, to the outside of the vehicle, and the second image display unit 131 is disposed in the outside of the vehicle for the second imaging device 150 provided in the vehicle 100.

The second image display unit 131 is disposed so as to display the second image at a predetermined position with respect to the second imaging device 150. Here, it is assumed that the second image display unit 131 is disposed so as to display the second image at a position facing the second imaging device 150. Here, the second image display unit 131 is assumed to include one image display surface, but may have a plurality of image display surfaces similarly to the first image display unit 121. Here, it is assumed that only the second imaging device 150, which is a sensor for peripheral monitoring included in the vehicle 100, is set as a processing target, and the second image display unit 131 is disposed so as to display the second image at a position facing the imaging device.

The second image displayed on the second image display unit 131 is an image to be used for calibration of the imaging device as described above, and the same image as the first image is basically used as the second image. The second image display unit 131 can display the same image as the first image as the second image by a display method similar to that of the first image display unit 121. On the other hand, as described above, the display of an image on the second image display unit 131 may be performed by projecting light from the first image display unit 121, for example. With such a configuration, it is possible to calibrate an imaging device that images the inside of a moving body and an imaging device that images the outside using the same image.

For example, in a vehicle, if a DMC and a peripheral monitoring sensor are not calibrated and a deviation remains, an adverse effect such as a decrease in accuracy of risk notification occurs. On the other hand, according to an image display apparatus that has such an arrangement and performs such display, it is possible to provide a configuration that accurately calibrates an imaging device that images the inside of a moving body and an imaging device that images the outside of the moving body.

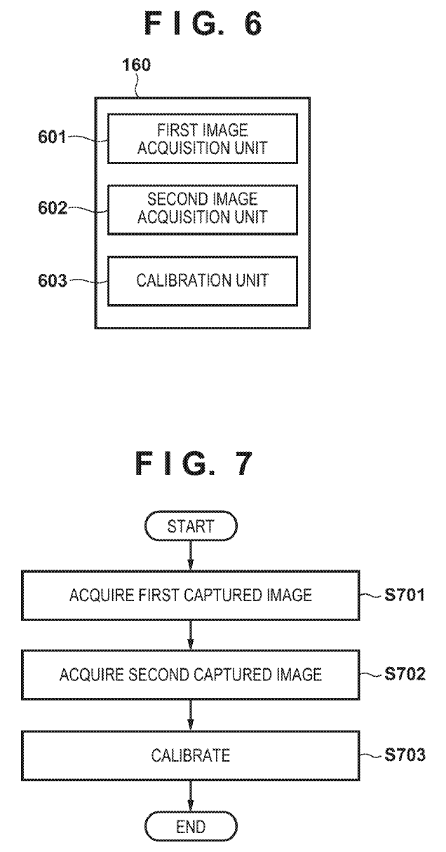

The information processing device 160 uses the image display apparatus 110 to calibrate the first imaging device 140 and the second imaging device 150. FIG. 6 is a block diagram illustrating an example of a functional configuration of the information processing device 160 according to the present embodiment. In FIG. 6, the information processing device 160 includes a first image acquisition unit 601, a second image acquisition unit 602, and a calibration unit 603.

The first image acquisition unit 601 acquires, by the first imaging device 140, a first captured image of the first image display unit 121 disposed for the first imaging device 140. Here, it is assumed that the internal parameters of the first imaging device are given in advance, and that coordinates of a feature portion of the first image displayed on the first image display unit 121 in the coordinate system of the first imaging device are acquired based on the first captured image.

The second image acquisition unit 602 acquires, by the second imaging device 150, a second captured image of the second image display unit 131 disposed for the second imaging device 150. Here, similarly to the first imaging device, it is assumed that the internal parameters of the second imaging device are given in advance, and that coordinates of a feature portion of the second image displayed on the second image display unit 131 in the coordinate system of the second imaging device are acquired based on the second captured image.

The calibration unit 603 calibrates the first imaging device 140 and the second imaging device 150 based on the first captured image and the second captured image. Here, the calibration unit 603 executes calibration based on the coordinates of the feature portion acquired from the first captured image in the coordinate system of the first imaging device, and the coordinates of the feature portion acquired from the second captured image in the coordinate system of the second imaging device. As the calibration processing performed by the calibration unit 603, generally executed calibration processing for an imaging device can be arbitrarily adopted, and a detailed description thereof will be omitted here.

FIG. 7 is a flowchart illustrating an example of calibration processing by the information processing device 160 according to the present embodiment. The processing illustrated in FIG. 7 is started in a case where the arrangement of the image display units using the image display apparatus 110 is completed and an execution command for the calibration processing is input to the information processing device 160.

In S701, the first image acquisition unit 601 acquires a first captured image of the first image display unit 121 by the first imaging device 140.

In S702, the second image acquisition unit 602 acquires a second captured image of the second image display unit 131 by the second imaging device 150.

In S703, the calibration unit 603 calibrates the first imaging device 140 and the second imaging device 150 based on the first captured image acquired in S701 and the second captured image acquired in S702, and terminates the processing in FIG. 7.

According to such a configuration, it is possible to calibrate a first imaging device and a second imaging device based on a first captured image of a first image display unit acquired by the first imaging device disposed so as to image an operator inside a moving body, and a second captured image of a second image display unit, which is disposed for a second imaging device, acquired by the second imaging device disposed so as to image the outside of the moving body. Therefore, it is possible to provide a configuration that accurately calibrates an imaging device that images the inside of a moving body and an imaging device that images the outside of the moving body.

### Summary of Embodiments

The above-described embodiment discloses at least the following image display apparatus, information processing device, and information processing method.

1. An image display apparatus according to the above embodiment is an image display apparatus configured to display an image to be used for calibration of an imaging device included in a moving body, the image display apparatus comprising:

a first protrusion having predetermined rigidity and including a first image display unit configured to display a first image and disposed for a first imaging device disposed so as to image an operator inside the moving body; and

a second protrusion having predetermined rigidity and including a second image display unit configured to display a second image and disposed for a second imaging device disposed so as to image an outside of the moving body.

According to the embodiment, it is possible to provide a configuration that accurately calibrates an imaging device that images the inside of a moving body and an imaging device that images the outside of the moving body.

2. In the image display apparatus according to the above embodiment,

the first image display unit is disposed so as to display the first image at a position facing the first imaging device, and

the second image display unit is disposed so as to display the second image at a position facing the second imaging device.

According to the embodiment, it is possible to strictly calibrate an imaging device that images the inside of a moving body and an imaging device that images the outside of the moving body.

3. In the image display apparatus according to the above embodiment,

the first image display unit is configured to display the first image by emitting light, and

the second image display unit is configured to display the second image by projecting light of the first image from the first image display unit.

According to the embodiment, it is possible to calibrate an imaging device that images the inside of a moving body and an imaging device that images the outside using the same image.

4. In the image display apparatus according to the above embodiment,

the first image display unit includes a plurality of image display surfaces, and each of the plurality of image display surfaces is configured to display the first image.

According to the embodiment, it is possible to appropriately calibrate a plurality of imaging devices that images the inside of a moving body.

5.In the image display apparatus according to the above embodiment,

the plurality of image display surfaces forms a polygonal prism.

According to the embodiment, it is possible to display calibration images in appropriate directions for a plurality of imaging devices that images the inside of a moving body.

6. In the image display apparatus according to the above embodiment,

at least some of the plurality of image display surfaces can control postures thereof.

According to the embodiment, it is possible to display calibration images in appropriate directions for a plurality of imaging devices that images the inside of a moving body.

7. In the image display apparatus according to the above embodiment,

the first image display unit is configured to display the first image by emitting light at a predetermined wavelength.

According to the embodiment, it is possible to display a calibration image at a wavelength suitable for a corresponding imaging device.

8. In the image display apparatus according to the above embodiment,

the first image display unit is configured to display the first image by emitting light at a visible light wavelength.

According to the embodiment, it is possible to display a calibration image at a wavelength suitable for a corresponding imaging device.

9. In the image display apparatus according to the above embodiment,

the first image display unit is configured to display the first image by emitting light at a non-visible light wavelength.

According to the embodiment, it is possible to display a calibration image at a wavelength suitable for a corresponding imaging device.

10. In the image display apparatus according to the above embodiment,

the first image display unit is disposed at a position corresponding to a feature portion of a head of the operator.

According to the embodiment, it is possible to easily integrate coordinates to be used for calibration.

11. An information processing device according to the above embodiment is an information processing apparatus configured to calibrate an imaging device included in a moving body, the information processing device comprising:

first acquisition unit configured to acquire, by a first imaging device disposed so as to image an operator inside the moving body, a first captured image of a first image display unit disposed for the first imaging device;

second acquisition unit configured to acquire, by a second imaging device disposed so as to image an outside of the moving body, a second captured image of a second image display unit disposed for the second imaging device; and

calibration unit configured to calibrate the first imaging device and the second imaging device based on the first captured image and the second captured image.

According to the embodiment, it is possible to provide a configuration that accurately calibrates an imaging device that images the inside of a moving body and an imaging device that images the outside of the moving body.

12. In the information processing device according to the above embodiment,

the first image display unit is disposed at a position corresponding to a feature portion of a head of the operator.

According to the embodiment, it is possible to easily integrate coordinates to be used for calibration.

13. An information processing method according to the above embodiment is an information processing method to be performed by an information processing device configured to calibrate an imaging device included in a moving body, the method comprising:

acquiring, by a first imaging device disposed so as to image an operator inside the moving body, a first captured image of a first image display unit disposed for the first imaging device;

acquiring, by a second imaging device disposed so as to image an outside of the moving body, a second captured image of a second image display unit disposed for the second imaging device; and

calibrating the first imaging device and the second imaging device based on the first captured image and the second captured image.

According to the embodiment, it is possible to provide a configuration that accurately calibrates an imaging device that images the inside of a moving body and an imaging device that images the outside of the moving body.

The invention is not limited to the foregoing embodiments, and various variations/changes are possible within the spirit of the invention.

What is claimed is:

1. An image display apparatus configured to display an image to be used for calibration of an imaging device included in a moving body, the image display apparatus comprising:
a first protrusion having predetermined rigidity and including a first image display unit configured to display a first image and disposed for a first imaging device disposed so as to image an operator inside the moving body; and
a second protrusion having predetermined rigidity and including a second image display unit configured to display a second image and disposed for a second imaging device disposed so as to image an outside of the moving body.

2. The image display apparatus according to claim 1, wherein
the first image display unit is disposed so as to display the first image at a position facing the first imaging device, and
the second image display unit is disposed so as to display the second image at a position facing the second imaging device.

3. The image display apparatus according to claim 1, wherein
the first image display unit is configured to display the first image by emitting light, and
the second image display unit is configured to display the second image by projecting light of the first image from the first image display unit.

4. The image display apparatus according to claim 1, wherein the first image display unit includes a plurality of image display surfaces, and each of the plurality of image display surfaces is configured to display the first image.

5. The image display apparatus according to claim 4, wherein the plurality of image display surfaces forms a polygonal prism.

6. The image display apparatus according to claim 4, wherein at least some of the plurality of image display surfaces can control postures thereof.

7. The image display apparatus according to claim 1, wherein the first image display unit is configured to display the first image by emitting light at a predetermined wavelength.

8. The image display apparatus according to claim 7, wherein the first image display unit is configured to display the first image by emitting light at a visible light wavelength.

9. The image display apparatus according to claim 7, wherein the first image display unit is configured to display the first image by emitting light at a non-visible light wavelength.

10. The image display apparatus according to claim 1, wherein the first image display unit is disposed at a position corresponding to a feature portion of a head of the operator.

11. An information processing device configured to calibrate an imaging device included in a moving body, the information processing device comprising:
first acquisition unit configured to acquire, by a first imaging device disposed so as to image an operator inside the moving body, a first captured image of a first image display unit disposed for the first imaging device;
second acquisition unit configured to acquire, by a second imaging device disposed so as to image an outside of the moving body, a second captured image of a second image display unit disposed for the second imaging device; and
calibration unit configured to calibrate the first imaging device and the second imaging device based on the first captured image and the second captured image.

12. The information processing device according to claim 11, wherein the first image display unit is disposed at a position corresponding to a feature portion of a head of the operator.

13. An information processing method to be performed by an information processing device configured to calibrate an imaging device included in a moving body, the method comprising:
acquiring, by a first imaging device disposed so as to image an operator inside the moving body, a first captured image of a first image display unit disposed for the first imaging device;
acquiring, by a second imaging device disposed so as to image an outside of the moving body, a second captured image of a second image display unit disposed for the second imaging device; and
calibrating the first imaging device and the second imaging device based on the first captured image and the second captured image.
